(19) United States
(12) Patent Application Publication
(10) Pub. No.: US 2026/0169158 A1
(43) Pub. Date: Jun. 18, 2026

(54) WEATHER OBSERVATION APPARATUS AND METHOD USING COMMUNICATION BASE STATIONS

(71) Applicant: ELECTRONICS AND TELECOMMUNICATIONS RESEARCH INSTITUTE, Daejeon (KR)

(72) Inventors: Seung-Hyun JANG, Daejeon (KR); Hyung-Ju KIM, Daejeon (KR); Seung-Keun PARK, Daejeon (KR); Sung-Jin YOO, Daejeon (KR); Jung-Hwan HWANG, Daejeon (KR)

(73) Assignee: ELECTRONICS AND TELECOMMUNICATIONS RESEARCH INSTITUTE, Daejeon (KR)

(21) Appl. No.: 19/416,073

(22) Filed: Dec. 11, 2025

(30) Foreign Application Priority Data
Dec. 12, 2024 (KR) 10-2024-0184577

(51) Int. Cl. G01S 13/95; G01W 1/10; H04W 72/0453

(52) U.S. Cl. CPC G01S 13/951; H04W 72/0453; G01W 1/10; G01W 2203/00

(57) ABSTRACT

Disclosed herein are a weather observation apparatus and method using communication base stations. The weather observation apparatus using communication base stations is configured to receive a sensing signal, obtained from a target object for weather observation, from at least one communication base station, correct the sensing signal using metadata based on at least one of a location of the communication base station, a condition of a communication network or a distance to the communication base station, or a combination thereof, analyze a weather change of the target object by analyzing a strength and a delay time of the sensing signal, and provide weather observation information to a user terminal based on the weather change.

### CROSS REFERENCE TO RELATED APPLICATION

This application claims the benefit of Korean Patent Application No. 10-2024-0184577, filed Dec. 12, 2024, which is hereby incorporated by reference in its entirety into this application.

### BACKGROUND OF THE INVENTION

### 1. Technical Field

The present disclosure relates generally to a weather observation technology, and more particularly to a weather observation technology using communication base stations.

### 2. Description of the Related Art

In 2010, the Gwanghwamun area was flooded, in 2011, a landslide occurred on Mt. Umyeon, and in August 2022, a heavy downpour of 141 mm per hour in Dongjak-gu, Seocho-gu, and Gangnam-gu caused flooding around Gangnam Station and on Subway Line 2. Due to the increasing frequency of such localized flash torrential rains, the need for low-altitude, high-resolution meteorological (weather) observation systems have emerged. In 2016, the Korea Meteorological Administration (KMA) attempted to introduce small weather radars to enable early detection of hazardous weather in the observation-blind zone below an altitude of 1 km. However, installation was canceled due to strong opposition from local residents related to electromagnetic-wave safety or the like, and the deployment of small radars has not been pursued since then.

Conventional weather observation is performed such that dual-polarization pulse-Doppler radars operating in the S-band or C-band and equipped with rotating antennas, sequentially transmit electromagnetic waves in all directions (360° azimuth, within 90° elevation), receive echo signals, and then apply signal-processing procedures to filter out non-precipitation echoes (terrain echoes, sea-clutter echoes, anomalous propagation echoes, solar interference echoes, chaff echoes, radio-interference echoes, etc.), and such that, after the signal-processing procedures, precipitation echoes are extracted and visualized. In addition, traditional weather observation radars are implemented as monostatic radars, in which a transmitter and a receiver are located at the same site. These weather radars are operated and managed by Korea's Weather Radar Center, wherein the KMA operates 11 units, the Ministry of Environment operates 7, and the Ministry of National Defense operates 9, allowing a total of 27 weather radars to be used jointly for weather observation.

Most weather radars are installed and operated not in the central urban areas but in high-elevation mountainous regions near cities. A small number of radars emitting high-power electromagnetic waves (approximately 750 kW) are distributed across locations suitable for observing wide areas. Although placing weather-observation radars in mountainous regions provides advantages in terms of wide observation coverage, there are disadvantages, such as observation blind spots caused by electromagnetic shadowing from nearby mountainous terrain and interference in precipitation echo observation due to non-precipitation echoes originating from the mountainous terrain. Conventional weather-observation radars can observe weather phenomena at altitudes above approximately 1.5 km Above Ground Level (AGL) from the urban surface. Therefore, although installing weather observation radars in central urban areas may be considered as one way to mitigate these observation blind spots, deploying such high-power radars in urban centers may cause additional issues, including electromagnetic interference.

Meanwhile, Korean Patent Application Publication No. US 2023/0161071 entitled “Method for distinguishing sunny-rainy weather based on time division long-term evolution network” discloses a method of extracting communication measurement statistics of time-division Long-Term Evolution (LTE) network base stations within a specific region to obtain rainfall characteristics, and calculating the reliability of a rainfall event at a specific location based on a comprehensive determination result derived from multiple base stations.

### SUMMARY OF THE INVENTION

Accordingly, the present disclosure has been made keeping in mind the above problems occurring in the prior art, and an object of the present disclosure is to allow a communication base station to additionally provide a weather observation function as well as an existing communication function by utilizing an existing wireless communication base station and a next-generation wireless communication base station system.

Another object of the present disclosure is to detect in real time sudden weather changes occurring in various terrains, including not only urban areas but also mountainous and coastal regions, and to establish a safety system for localized weather forecasting and disaster response based on such detection.

A further object of the present disclosure is to collect weather information over a wide area and integrate metadata collected from a communication network, thus providing high-precision weather analysis information, such as localized precipitation, landslide risks, and weather changes, in real time.

Yet another object of the present disclosure is to establish a comprehensive weather observation and user service system that provides personalized weather information to a user and proposes customized pricing plans and services according to weather changes.

Still another object of the present disclosure is to identify sensing signals from multiple wireless communication base stations and individually or cooperatively use the sensing signals, thus eliminating observation blind spots of conventional weather-observation radars and improving the distance resolution of weather observations.

In accordance with an aspect of the present disclosure to accomplish the above objects, there is provided a weather observation apparatus using communication base stations, including one or more processors, and memory configured to store at least one program that is executed by the one or more processors, wherein the at least one program is configured to receive a sensing signal, obtained from a target object for weather observation, from at least one communication base station, correct the sensing signal using metadata based on at least one of a location of the communication base station, a condition of a communication network or a distance to the communication base station, or a combination thereof, analyze a weather change of the target object by analyzing a strength and a delay time of the sensing signal, and provide weather observation information to a user terminal based on the weather change.

Here, the communication base station may receive a sensing signal that is reflected from the target object when an additional communication base station transmits a transmission signal to the target object.

Here, the at least one program may be configured to estimate three-dimensional (3D) coordinates of a rain cloud by forming ellipsoids in a 3D coordinate system using a propagation path based on coordinate information of communication base stations and a delay time between a transmission signal and a sensing signal of the communication base stations.

Here, the at least one program may be configured to determine whether the target object is at a landslide risk based on a phase variation and a magnitude variation of the sensing signal.

Here, the at least one program may be configured to provide a weather observation service for delivering personalized weather observation information and provide a customized pricing plan based on at least one of a location, an environment or a communication network condition of the user terminal, or a combination thereof.

Here, the at least one program may be configured to schedule a frequency-resource utilization ratio for allocating frequency resources of the communication base station between a communication purpose and a sensing purpose for weather observation.

Here, the at least one program may be configured to allocate any one of the communication purpose and the sensing purpose for weather observation to each of frequency resource blocks included in each time slot corresponding to Orthogonal Frequency-Division Multiplexing (OFDM) symbols.

Here, the at least one program may be configured to, when a frequency resource block to which the communication purpose is allocated and a frequency resource block to which the sensing purpose is allocated are adjacent to each other, insert a guard interval into the frequency resource block to which the sensing purpose is allocated.

Here, the at least one program may be configured to schedule a number of sensing purposes allocated to the frequency resource blocks based on a preset resolution for collecting the sensing signal.

In accordance with another aspect of the present disclosure to accomplish the above objects, there is provided a weather observation method using communication base stations, performed by a weather observation apparatus using communication base stations, the weather observation method including receiving a sensing signal, obtained from a target object for weather observation, from at least one communication base station; analyzing a weather change of the target object by analyzing a strength and a delay time of the sensing signal; and providing weather observation information to a user terminal based on the weather change, wherein receiving the sensing signal includes correcting the sensing signal using metadata based on at least one of a location of the communication base station, a condition of a communication network or a distance to the communication base station, or a combination thereof.

Here, the communication base station may receive a sensing signal that is reflected from the target object when an additional communication base station transmits a transmission signal to the target object.

Here, analyzing the weather change may include estimating three-dimensional (3D) coordinates of a rain cloud by forming ellipsoids in a 3D coordinate system using a propagation path based on coordinate information of communication base stations and a delay time between a transmission signal and a sensing signal of the communication base stations.

Here, analyzing the weather change may include determining whether the target object is at a landslide risk based on a phase variation and a magnitude variation of the sensing signal.

Here, providing the weather observation information may include providing a weather observation service for delivering personalized weather observation information and providing a customized pricing plan based on at least one of a location, an environment or a communication network condition of the user terminal, or a combination thereof.

Here, the weather observation method may further include scheduling a frequency-resource utilization ratio for allocating frequency resources of the communication base station between a communication purpose and a sensing purpose for weather observation.

Here, scheduling the frequency-resource utilization ratio may include allocating any one of the communication purpose and the sensing purpose for weather observation to each of frequency resource blocks included in each time slot corresponding to Orthogonal Frequency-Division Multiplexing (OFDM) symbols.

Here, scheduling the frequency-resource utilization ratio may further include when a frequency resource block to which the communication purpose is allocated and a frequency resource block to which the sensing purpose is allocated are adjacent to each other, inserting a guard interval into the frequency resource block to which the sensing purpose is allocated.

Here, scheduling the frequency-resource utilization ratio may further include scheduling a number of sensing purposes allocated to the frequency resource blocks based on a preset resolution for collecting the sensing signal.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a weather observation system using communication base stations according to an embodiment of the present disclosure;

FIGS. 2 to 4 are diagrams illustrating a weather observation process using communication base stations according to an embodiment of the present disclosure;

FIG. 5 is a block diagram illustrating a weather observation system using communication base stations according to an embodiment of the present disclosure;

FIG. 6 is a block diagram illustrating in detail a central unit that is an example of a weather observation apparatus using communication base stations, illustrated in FIG. 5;

FIG. 7 is an operation flowchart illustrating a weather observation method using communication base stations according to an embodiment of the present disclosure;

FIGS. 8 and 9 are diagrams illustrating ISAC signal scheduling for weather observation according to an embodiment of the present disclosure;

FIG. 10 is a diagram illustrating a weather observation system using communication base stations for landslide forecasting according to an embodiment of the present disclosure;

FIGS. 11 and 12 are diagrams illustrating changes in numerology depending on measurement distance according to an embodiment of the present disclosure;

FIGS. 13 and 14 are diagrams illustrating changes in the number of Resource Blocks (RBs) depending on the required resolution according to an embodiment of the present disclosure;

FIG. 15 is a diagram illustrating a process of extracting information about a target object using multiple communication base stations according to an embodiment of the present disclosure;

FIG. 16 is a diagram illustrating the Cyclic Prefix (CP) length of a sensing symbol according to an embodiment of the present disclosure; and

FIG. 17 is a diagram illustrating a computer system according to an embodiment of the present disclosure.

### DESCRIPTION OF THE PREFERRED EMBODIMENTS

The present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the present disclosure to those skilled in the art. Therefore, the shapes, sizes, etc. of elements in the drawings may be exaggerated for clear illustration.

In the entire specification, when a certain element is described as “comprising” or “including” a specific component, it means that, unless explicitly stated otherwise, the certain element may further include additional components without excluding the additional components.

The present disclosure may be variously modified and may have various embodiments, and the embodiments are intended to be illustrated and described in detail in the accompanying drawings.

However, this is not intended to limit the present disclosure to particular embodiments, and it should be appreciated that all changes, equivalents, and substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. Terms that are generally defined in commonly used dictionaries should be construed as having meanings consistent with their contextual usage in the relevant technical field, and, unless explicitly defined in this application, and should not be construed in an idealized or unduly formal sense.

It will be understood that when a component is referred to as being “associated” with another component, it can be directly associated with or connected to the other component, but other intervening components may be present therebetween.

The terms used in the present disclosure are used only to describe a specific embodiment, and are not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In the description of the present disclosure, independent reference numerals are used to designate the same components in the drawings to facilitate overall understanding.

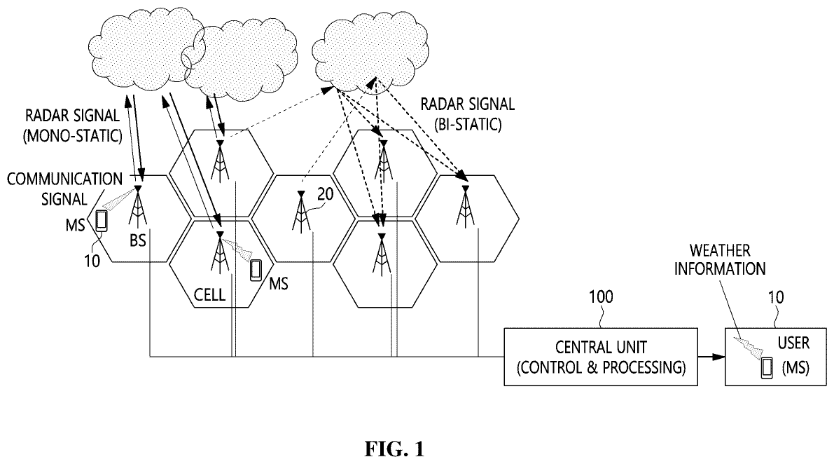

FIG. 1 is a diagram illustrating a weather observation system using communication base stations according to an embodiment of the present disclosure.

Referring to FIG. 1, the weather observation system using communication base stations according to the embodiment of the present disclosure may be implemented as an Integrated Sensing and Communications (ISAC) system that integrates weather-observation functions, such as estimating the moisture content and movement speed of rain clouds, estimating a rainfall amount, and classifying precipitation echoes and non-precipitation echoes, into a communication network and performs those functions in an integrated manner.

The weather observation system using communication base stations may include a central processing unit (hereinafter also referred to as a ‘central unit’) 100 that is a weather observation apparatus using communication base stations, a user terminal (mobile station) 10, and communication base stations 20.

The weather observation system using communication base stations may collect weather information over a wide area through bistatic and multistatic radar operations by utilizing a structure in which multiple communication base stations 20 are deployed at different locations.

Here, the weather observation system using communication base stations may transmit sensing signals into the atmosphere to perform weather observation and individually receive signals scattered by rain clouds or the like by utilizing multiple communication base stations 20 used for wireless communication.

Here, the weather observation apparatus 100 using communication base stations may integrate weather signals with metadata collected from the communication network of the communication base stations 20 to provide high-precision weather-analysis information, such as localized precipitation, landslide risks, and weather changes, to the user terminal 10 in real time.

Here, the weather observation apparatus 100 using communication base stations may collect the received sensing signals, convert the sensing signals into data for weather analysis, and thereafter transmit weather observation information to the user terminal 10 in real time through a medium such as a smartphone application or a website.

Here, the metadata refers to information related to the communication base stations 20 and various types of additional data collected from the network. For example, the metadata may include the location information of the communication base stations 20, the distance between the base stations, the deployment pattern of the base stations, the antenna pattern and performance information of the base stations, and the like.

Here, the weather observation system using communication base stations may include both a monostatic radar scheme in which the locations of a transmitter and a receiver are identical to each other and a bistatic radar scheme in which the locations of a transmitter and a receiver are different from each other.

The weather observation apparatus 100 using communication base stations may observe moisture-content information of a target object through bistatic or multistatic radar signal-processing techniques that utilize communication base stations.

Unlike conventional monostatic-based weather radar systems, bistatic and multistatic radar operations may utilize the communication base stations 20 to allow signals to be received from multiple directions (angles) over a wide area through multiple communication base stations in which the transmitter and the receiver are deployed at different locations, or through a separate reception device, thus enabling weather phenomena to be more precisely detected and analyzed.

Here, one or more communication base stations 20 may transmit transmission signals for weather observation to the target object, and the one or more communication base stations 20 or the separate reception device may receive reflected signals generated when the transmission signals are scattered or reflected by the moisture content of the target object such as rain clouds or mountainous terrain.

In the weather observation apparatus 100 using communication base stations, the multiple communication base stations 20 may collect and analyze reflected signals at different locations.

The communication base stations may collect mutually complementary data thereamong through the configuration of bistatic and multistatic radar operations.

That is, each communication base station 20 may receive a reflected signal that is transmitted from another communication base station 20 to the target object and is reflected from the target object, and may convert the reflected signal into a sensing signal.

By means of this, the weather observation apparatus 100 using communication base stations may analyze localized weather phenomena occurring at various locations with high precision, and may perform precise weather observation even in complex terrains such as mountainous regions.

The weather observation apparatus 100 using communication base stations may integrate the received sensing signals with the metadata of the communication network, and may then convert the integrated signal into data for weather analysis.

In this case, the weather observation apparatus 100 using communication base stations may integrate existing communication infrastructures with the metadata to perform weather observation, thus more precisely correcting the sensing signals using various types of metadata such as the locations of communication base stations, the status of communication traffic, and the distance between base stations. Through this process, the weather observation apparatus 100 using communication base stations may more accurately forecast localized weather changes, and may significantly improve analysis efficiency and accuracy compared to conventional weather radar systems.

In the case of communication traffic, the amount of real-time communication traffic processed by the base stations may also be important metadata. As the amount of traffic is larger, the transmission/reception speed of weather information may be further influenced. In consideration of this, strategic decisions, such as adjusting the transmission priority of weather information, or transmitting data while avoiding base stations with high communication loads, may be made.

The weather observation apparatus 100 using communication base stations may provide a user-personalized weather information service and a disaster-response system to the user terminal 10 based on moisture-content information.

Here, the weather observation apparatus 100 using communication base stations may forecast localized precipitation changes, landslide risks, and other weather changes in real time through weather analysis, and may provide the user terminal 10 with real-time weather information tailored to the user's location and environment.

Here, the weather observation apparatus 100 using communication base stations may provide the user terminal 10 in real time with the moisture-content information and weather changes in conformity with the location, environment, and communication network conditions of the user terminal 10 based on the weather analysis data, may propose customized pricing plans matching the weather conditions to the user terminal 10, and may provide a personalized weather observation service to the user.

Here, unlike conventional weather radars, the weather observation apparatus 100 using communication base stations may additionally perform a weather observation function while utilizing the existing communication infrastructures without change, thus reducing cost without additional hardware installation. Furthermore, the weather observation apparatus 100 using communication base stations may greatly improve system efficiency through a combination of the communication function and the weather observation function.

In this case, because the communication base stations 20 are already densely deployed across various regions, the weather observation apparatus 100 using communication base stations may transmit and receive weather signals in real time in diverse terrains such as mountainous regions, coastal areas, and urban areas, and may perform weather observation over a wider area than that of conventional weather radar systems. By means of this, the weather observation technology may be applied to a broader variety of environments.

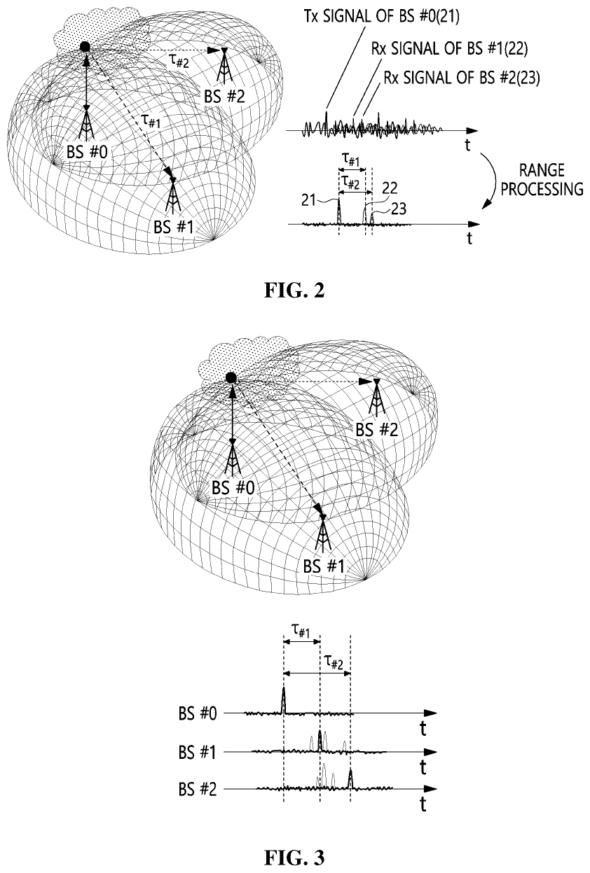

FIGS. 2 to 4 are diagrams illustrating a weather observation process using communication base stations according to an embodiment of the present disclosure.

Referring to FIGS. 2 to 4, it can be seen that a weather observation process for rain cloud location detection and rain cloud imaging using the communication base stations 20 is illustrated. In the case of 5G wireless communication, an Orthogonal Frequency-Division Multiplexing (OFDM) scheme is employed, and next-generation wireless communication beyond 6G is also expected to employ the OFDM scheme or a scheme similar to OFDM. Therefore, although, in the present disclosure, embodiments are described in consideration of the OFDM scheme, the transmission waveform of the present disclosure is not limited to OFDM, and any waveform may be used as the transmission waveform.

A weather radar may measure a radar reflectivity factor Z, and may use Z for precipitation estimation. The radar reflectivity factor uses the unit of [mm⁶/m3] and is typically represented by dBZ. The radar reflectivity factor may be represented by the following Equation (1):

$$Z [ dBZ ] = 10 log ( \frac{Z}{1 {mm}^{6} / {m}^{3}} ) \qquad ( 1 )$$

In Equation (1), a single water droplet with a diameter of 1 mm within a unit volume of 1 m³ corresponds to 0 dBZ, 10 droplets correspond to 10 dBZ, and 100 droplets correspond to 20 dBZ. Each value of the radar reflectivity factor may be associated with rainfall phenomena, as shown in the following Table 1.

TABLE 1

| Z (dBZ) | R(mm/h) | R(in/h) | Intensity |
|---|---|---|---|
| 5 | 0.07 | <0.01 | Trace accumulation of mist |
| 10 | 0.15 | <0.01 | Trace accumulation of mist |
| 15 | 0.8 | 0.01 | Trace accumulation |
| 20 | 0.6 | 0.02 | Light rain |
| 25 | 1.8 | 0.06 | Light rain |
| 30 | 2.7 | 0.10 | Light to moderate rain |
| 35 | 5.6 | 0.22 | Moderate rain |
| 40 | 11.58 | 0.45 | Moderate to heavy rain |
| 45 | 23.7 | 0.92 | Heavy rain |
| 50 | 48.6 | 1.90 | Heavy rain, small hail possible |
| 55 | 100 | 4 | Very heavy rain, hail possible |
| 60 | 205 | 8 | Very heavy rain, hail likely |
| 65 | 421 | 16.6 | Very heavy rain, hail very likely, |
| | | | large hail possible |

Generally, the radar may emit electromagnetic waves in the direction of the same range axis, and the distance resolution by which two targets having different distances are identified may be calculated using the following Equation (2).

$$Δ R = \frac{c}{2 BW} \qquad ( 2 )$$

In Equation (2), ΔR denotes the distance resolution, c denotes light speed (3×10⁸ [m/sec]) and Bandwidth (BW) denotes the bandwidth of a radiated electromagnetic wave. That is, the distance resolution in the direction of the same distance axis is in inverse proportion to the bandwidth. Ae wider the bandwidth, the better the distance resolution, enabling more precise target observation. In the case of weather radars, the bandwidth that is used is typically about 10 MHz, a 4G LTE communication scheme uses the maximum channel bandwidth of 20 MHz, and 5G New Radio (NR) base stations operating below 7 GHz use a maximum channel bandwidth of 100 MHz. Therefore, conventional 4G/5G communication base stations may provide higher distance resolution than that of weather radars.

The communication base stations 20 may be implemented in bistatic and multistatic forms. When a signal 21 transmitted from base station BS #0 is scattered by a localized rain cloud region and is then received by nearby base stations BS #1 and BS #2, if the nearby base stations have information about the transmission waveform 21 of the transmitting base station BS #0, respective delay times Ô_{#1} and Ô_{#2} of reception waveforms 22 and 23 of BS #1 and BS #2 may be calculated. Since radio waves propagate at the speed of light, each delay time is converted into a propagation path. Further, based on the coordinate information of BS #0 and BS #1, ellipsoids in which respective positions of BS #0 and BS #1 are set as the foci of ellipses and which have the same propagation path may be formed. The same process may also be applied to BS #0 and BS #2 to form other ellipsoids. The region where the two ellipsoids intersect in a three-dimensional (3D) coordinate system is represented by a curve, and an additional transmitter-receiver base-station pair exists, and thus the region where three ellipsoids intersect may be calculated as a single point. Although only two transmitter-receiver base-station pairs are illustrated in FIGS. 2 to 4 for convenience of understanding, three or more transmitter-receiver base station pairs may be actually required.

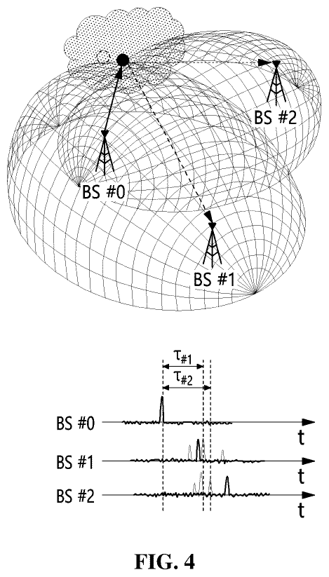

From a radar perspective, rain clouds may be observed as multiple targets distributed over a wide area, unlike targets, each appearing as a single point, such as airplanes or UAVs. Therefore, as in the case of BS #1 and BS #2 in FIGS. 3 and 4, rain clouds may be observed as having multiple propagation delay times, that is, multiple propagation paths.

Here, the weather observation apparatus 100 using communication base stations may form ellipsoids having individual propagation paths in case that the coordinates of the transmitter base station and the coordinates of the receiver base station are known.

In this case, the weather observation apparatus 100 using communication base stations may sequentially estimate the 3D coordinates of localized regions of rain clouds by using the respective propagation paths, and may also obtain rain-cloud images.

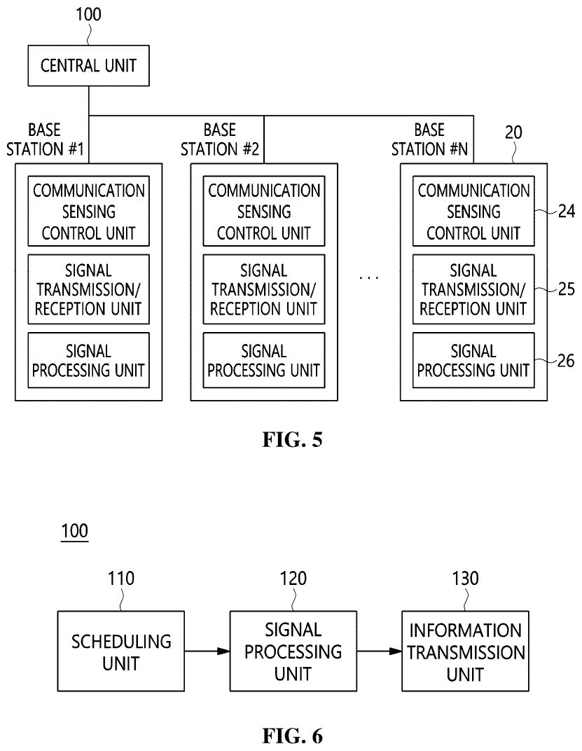

FIG. 5 is a block diagram illustrating a weather observation system using communication base stations according to an embodiment of the present disclosure. FIG. 6 is a block diagram illustrating in detail a central unit that is an example of a weather observation apparatus using communication base stations, illustrated in FIG. 5.

Referring to FIG. 5, the weather observation system using communication base stations may include multiple communication base stations 20 and a central unit 100.

Each of the communication base stations 20 may include a communication sensing control unit 24, a signal transmission/reception unit 25, and a signal processing unit 26.

Referring to FIG. 6, the central unit 100 that is a weather observation apparatus using communication base stations according to an embodiment of the present disclosure may include a scheduling unit 110, a signal processing unit 120, and an information transmission unit 130.

The scheduling unit 110 may schedule a frequency-resource utilization ratio for allocating the frequency resources of the corresponding communication base station 20 between a communication purpose and a sensing purpose for weather observation.

Here, the scheduling unit 110 may schedule the frequency-resource utilization ratio so that frequency resources given during a specific time period can be utilized only for communication or only for sensing, or can be utilized in various manners within a frequency bandwidth fixedly secured for the communication and sensing service.

Here, the scheduling unit 110 may determine the frequency-resource utilization ratio in consideration of resources such as the number of communication users connected within the cell coverage of the corresponding base station and the amount of data usage, and may dynamically schedule the frequency-resource utilization ratio depending on the situation.

Here, the scheduling unit 110 may allocate any one of the communication purpose and the sensing purpose for weather observation to each of frequency resource blocks included in each time slot corresponding to OFDM symbols.

Here, when frequency resources are used for sensing, the scheduling unit 110 may insert a guard interval to avoid interference with communication signals.

Here, when a frequency resource block to which the communication purpose is allocated and a frequency resource block to which the sensing purpose is allocated are adjacent to each other, the scheduling unit 110 may insert a guard interval into the frequency resource block to which the sensing purpose is allocated.

Here, the scheduling unit 110 may schedule the number of sensing purposes to be allocated to the frequency resource blocks based on preset resolution required for collecting sensing signals.

Further, the sensing signals may include not only sensing signals for the weather observation purpose, but also other types of sensing information in Unmanned Aerial Vehicle (UAV) detection and traffic monitoring.

Here, the communication sensing control unit 24 may distinguish the communication base stations 20 from each other based on cell ID signals periodically transmitted from the communication base stations 20, and may receive signals reflected through the communication base stations 20, thus enabling signals to be identified from the perspective of base stations.

The communication sensing control unit 24 may deliver sensing control information to the communication sensing control unit 24 of each base station 20 after scheduling is processed.

The communication sensing control unit 24 may adjust beam-pattern synthesis for weather observation, beam-steering angles, transmission signal power, the waveform of sensing signals, and the like.

The signal transmission/reception unit 25 of each communication base station 20 may transmit sensing signals to the target object.

The signal transmission/reception unit 25 of each communication base station 20 may receive a reflected signal reflected from the target object.

Here, at least one communication base station 20 may transmit a transmission signal for weather observation to the target object, and the at least one communication base station 20 or the separate reception device may receive a reflected signal generated when the transmission signal is scattered or reflected by the moisture content of the target object such as rain clouds or mountain terrain.

Further, the signal processing unit 26 may convert the received reflected signal into a sensing signal for weather analysis.

Here, the signal processing unit 120 may receive the sensing signal obtained from the target object for weather observation from the corresponding communication base station.

Here, the signal processing unit 120 may analyze the strength and delay time of the sensing signal, thus analyzing weather changes of the target object.

Here, the signal processing unit 120 may correct the sensing signal using metadata based on at least one of the location of each communication base station, the conditions of a communication network or the distance to the communication base station, or a combination thereof.

Here, the signal processing unit 120 may form ellipsoids in a 3D coordinate system using a propagation path based on both the coordinate information of communication base stations and the delay time between transmission signals and sensing signals of the communication base stations, thus estimating the 3D coordinates of rain clouds.

Here, the signal processing unit 120 may estimate the 3D coordinates of the rain clouds based on regions in which three ellipsoids formed from three or more pairs of communication base stations intersect.

Here, the signal processing unit 120 may determine whether the target object is at risk of a landslide based on phase variations and magnitude variations of the sensing signals.

Here, the signal processing unit 120 may perform image processing that represents reflectivity of echo signals, radial velocity, differential reflectivity, differential phase, and cross-correlation coefficient on rain clouds or the like to perform weather analysis.

Here, the signal processing unit 120 may perform various types of threshold processing, filtering, or the like to enhance the quality and accuracy of individual images.

Here, the signal processing unit 120 may perform weather analysis from the sensing signals obtained from the target object to perform such weather observation.

Here, the signal processing unit 120 may observe moisture-content information of the target object through a bistatic or multistatic radar signal processing technology using the communication base stations.

Here, the signal processing unit 120 may estimate the location and moisture-content information of the target object by analyzing the strength and delay time of each sensing signal.

Here, a strong reflected signal may represent higher moisture content, and a weak reflected signal may represent low moisture content or clouds composed of smaller particles.

Unlike conventional monostatic-based weather radar systems, bistatic and multistatic radar operations may utilize the communication base stations 20 to allow signals to be received from multiple directions (angles) over a wide area through multiple communication base stations in which the transmitter and the receiver are deployed at different locations, or through a separate reception device, thus enabling weather phenomena to be more precisely detected and analyzed.

Here, the signal processing unit 120 may integrate weather signals with metadata collected from the communication network of the communication base stations 20.

Here, the metadata refers to information related to the communication base stations 20 and various types of additional data collected from the network. For example, the metadata may include the location information of the communication base stations 20, the distance between the base stations, the deployment pattern of the base stations, the antenna pattern and performance information of the base stations, and the like.

Here, the signal processing unit 120 may collect the received sensing signals and convert the sensing signals into data for weather analysis.

Here, the signal processing unit 120 may integrate existing communication infrastructures with metadata to perform weather observation, thus more precisely correcting the weather data using various types of metadata such as the locations of communication base stations, the status of communication traffic, and the distance between base stations. Through this process, the signal processing unit 120 may more accurately forecast localized weather changes, and may significantly improve analysis efficiency and accuracy compared to conventional weather radar systems.

In the case of communication traffic, the amount of real-time communication traffic processed by the base stations may also be important metadata. As the amount of communication traffic is larger, the transmission/reception speed of weather information may be further influenced.

By means of this, the signal processing unit 120 may adjust the transmission priority of weather information or make a strategic decision for transmitting data while avoiding a base station having a higher communication load.

The information transmission unit 130 may finally deliver weather information to the user terminal 10 through a medium such as a smartphone application or a website.

Here, the information transmission unit 130 may provide high-precision weather analysis information, such as localized precipitation, landslide risks, or weather changes, to the user terminal 10 in real time.

Here, the information transmission unit 130 may transmit the weather observation information to the user terminal 10 in real time through a medium such as a smartphone application or a website.

Here, the information transmission unit 130 may provide a user-personalized weather information service and a disaster-response system to the user terminal 10 based on moisture-content information.

Here, the information transmission unit 130 may provide the user terminal 10 with real-time weather information tailored to the user's location and environment based on the results of forecasting localized precipitation changes, landslide risks, and other weather changes in real time through weather analysis.

Here, the information transmission unit 130 may provide the user terminal 10 in real time with the moisture-content information and weather changes in conformity with the location, environment, and communication network conditions of the user based on the weather analysis data, may propose customized pricing plans matching the weather conditions to the user terminal 10, and may provide a personalized service to the user.

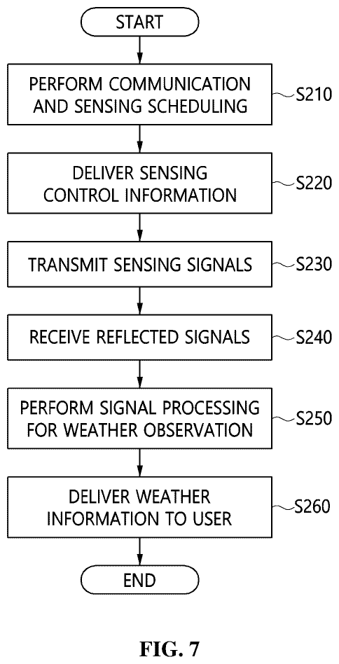

FIG. 7 is an operation flowchart illustrating a weather observation method using communication base stations according to an embodiment of the present disclosure.

Referring to FIG. 7, the weather observation method using communication base stations according to the embodiment of the present disclosure may first perform communication and sensing scheduling at step S210.

That is, step S210 may schedule a frequency-resource utilization ratio for allocating the frequency resources of each communication base station 20 between a communication purpose and a sensing purpose for weather observation.

Here, step S210 may schedule the frequency-resource utilization ratio so that frequency resources given during a specific time period can be utilized only for communication or only for sensing or can be utilized in various manners within a frequency bandwidth fixedly secured for the communication and sensing service.

Here, step S210 may determine the frequency-resource utilization ratio in consideration of resources such as the number of communication users connected within the cell coverage of the corresponding base station and the amount of data usage, and may dynamically perform the scheduling depending on the situation.

Here, step S210 may allocate any one of the communication purpose and the sensing purpose for weather observation to each of frequency resource blocks included in each time slot corresponding to OFDM symbols.

Here, when frequency resources are used for sensing, step S210 may insert a guard interval to avoid interference with communication signals.

Here, when a frequency resource block to which the communication purpose is allocated and a frequency resource block to which the sensing purpose is allocated are adjacent to each other, step S210 may insert a guard interval into the frequency resource block to which the sensing purpose is allocated.

Here, step S210 may schedule the number of sensing purposes to be allocated to the frequency resource blocks based on preset resolution required for collecting sensing signals.

Further, the sensing signals may include not only sensing signals for the weather observation purpose, but also other types of sensing information in Unmanned Aerial Vehicle (UAV) detection and traffic monitoring.

Here, step S210 may distinguish the communication base stations 20 from each other based on cell ID signals periodically transmitted from the communication base stations 20, and may receive signals reflected through the communication base stations 20, thus enabling signals to be identified from the perspective of base stations.

Further, the weather observation method using communication base stations according to the embodiment of the present disclosure may deliver sensing control information at step S220.

That is, step S220 may deliver sensing control information to the control unit 24 of each base station 20 after scheduling is processed.

Here, step S220 may adjust beam-pattern synthesis for weather observation, beam-steering angles, transmission signal power, the waveform of sensing signals, and the like.

Furthermore, the weather observation method using communication base stations according to the embodiment of the present disclosure may transmit the sensing signals at step S230.

That is, at step S230, the communication base stations may transmit the sensing signals to the target object.

Here, at step S230, at least one communication base station 20 may transmit a transmission signal for weather observation to the target object.

Furthermore, the weather observation method using communication base stations according to the embodiment of the present disclosure may receive reflected signals at step S240.

That is, at step S240, each of the communication base stations may receive a reflected signal that is reflected from the target object.

Here, at step S240, the one or more communication base stations 20 or separate reception apparatus may receive a reflected signal that is generated when the transmission signal is scattered or reflected by the moisture content of the target object such as rain clouds or mountain terrain.

Furthermore, the weather observation method using communication base stations according to the embodiment of the present disclosure may perform signal processing for weather observation at step S250.

That is, at step S250, the received reflected signal may be converted into a sensing signal for weather analysis.

Here, step S250 may receive the sensing signal obtained from the target object for weather observation from the corresponding communication base station.

Here, step S250 may analyze the strength and delay time of the sensing signal, thus analyzing weather changes of the target object.

Here, step S250 may correct the sensing signal using metadata based on at least one of the location of each communication base station, the conditions of a communication network or the distance to the communication base station, or a combination thereof.

Here, step S250 may form ellipsoids in a 3D coordinate system using a propagation path based on both the coordinate information of communication base stations and the delay time between transmission signals and sensing signals of the communication base stations, thus estimating the 3D coordinates of rain clouds.

Here, step S250 may estimate the 3D coordinates of the rain clouds based on regions in which three ellipsoids formed from three or more pairs of communication base stations intersect.

Here, step S250 may determine whether the target object is at risk of a landslide based on phase variations and magnitude variations of the sensing signals.

Here, step S250 may perform image processing that represents reflectivity of echo signals, radial velocity, differential reflectivity, differential phase, cross-correlation coefficient, and the like on rain clouds or the like to perform weather analysis.

Here, step S250 may perform various types of threshold processing, filtering, or the like to enhance the quality and accuracy of individual images.

Here, step S250 may perform weather analysis from the signals for weather analysis.

Here, step S250 may observe moisture-content information of the target object through a bistatic or multistatic radar signal processing technology using the communication base stations.

Here, step S250 may estimate the location and moisture-content information of the target object by analyzing the strength and delay time of each sensing signal.

Here, a strong reflected signal may represent higher moisture content, and a weak reflected signal may represent low moisture content or clouds composed of smaller particles.

Unlike conventional monostatic-based weather radar systems, bistatic and multistatic radar operations may utilize the communication base stations 20 to allow signals to be received from multiple directions (angles) over a wide area through multiple communication base stations in which the transmitter and the receiver are deployed at different locations, or through a separate reception device, thus enabling weather phenomena to be more precisely detected and analyzed.

Here, step S250 may integrate weather signals with metadata collected from the communication network of the communication base stations 20.

Here, the metadata refers to information related to the communication base stations 20 and various types of additional data collected from the network. For example, the metadata may include the location information of the communication base stations 20, the distance between the base stations, the deployment pattern of the base stations, the antenna pattern and performance information of the base stations, and the like.

Here, step S250 may collect the received sensing signals and convert the sensing signals into data for weather analysis.

Here, step S250 may integrate existing communication infrastructures with metadata to perform weather observation, thus more precisely correcting the weather data using various types of metadata such as the locations of communication base stations, the status of communication traffic, and the distance between base stations. Through this process, the signal processing unit 120 may more accurately forecast localized weather changes, and may significantly improve analysis efficiency and accuracy compared to conventional weather radar systems.

In the case of communication traffic, the amount of real-time communication traffic processed by the base stations may also be important metadata. As the amount of communication traffic is larger, the transmission/reception speed of weather information may be further influenced.

By means of this, step S250 may adjust the transmission priority of weather information or make a strategic decision for transmitting data while avoiding a base station having a higher communication load.

Furthermore, the weather observation method using communication base stations according to the embodiment of the present disclosure may deliver the weather information at step S260.

That is, step S260 may finally deliver weather information to the user terminal 10 through a medium such as a smartphone application or a website.

Here, step S260 may provide high-precision weather analysis information, such as localized precipitation, landslide risks, or weather changes, to the user terminal 10 in real time.

Here, step S260 may transmit the weather observation information to the user terminal 10 in real time through a medium such as a smartphone application or a website.

Here, step S260 may provide a user-personalized weather information service and a disaster-response system to the user terminal 10 based on moisture-content information.

Here, step S260 may provide the user terminal 10 with real-time weather information tailored to the user's location and environment based on the results of forecasting localized precipitation changes, landslide risks, and other weather changes in real time through weather analysis.

Here, step S260 may provide the user terminal 10 in real time with the moisture-content information and weather changes in conformity with the location, environment, and communication network conditions of the user based on the weather analysis data, may propose customized pricing plans matching the weather conditions to the user terminal 10, and may provide a personalized service to the user.

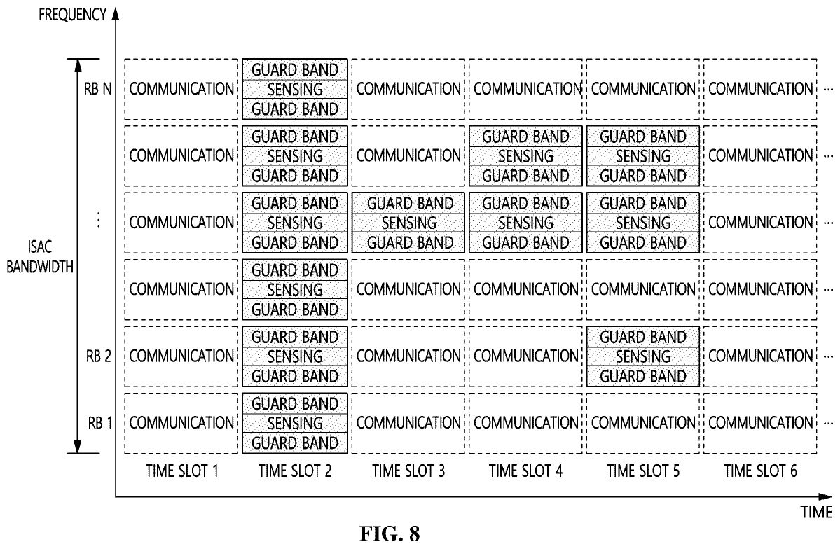

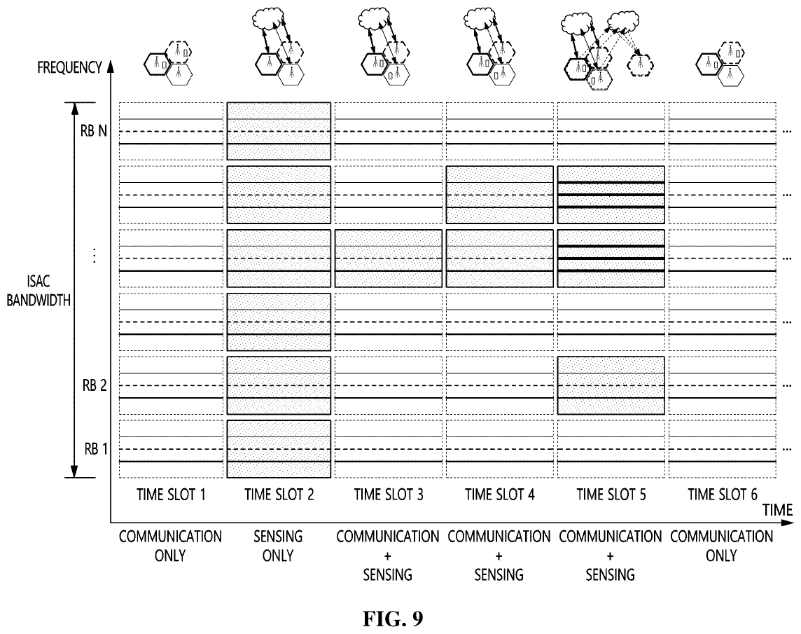

FIGS. 8 and 9 are diagrams illustrating ISAC signal scheduling for weather observation according to an embodiment of the present disclosure.

Referring to FIGS. 8 and 9, it can be seen that Integrated Sensing and Communications (ISAC) signal scheduling used in the weather observation apparatus and method using communication base stations according to embodiments of the present disclosure is illustrated.

The ISAC signal scheduling may utilize time and frequency resources for performing communication along with sensing. In the case of 5G wireless communication, an Orthogonal Frequency-Division Multiplexing (OFDM) scheme is employed, and next-generation wireless communication beyond 6G is also expected to employ the OFDM scheme or a scheme similar to OFDM. Therefore, embodiments of the present disclosure will also be described in consideration of the OFDM scheme.

It can be seen that each frequency Resource Block (RB) of FIGS. 8 and 9 may correspond to a group of available subcarriers within a bandwidth, and each time slot may correspond to an OFDM symbol group.

RB may be a single subcarrier, or a group of multiple subcarriers. A time slot may also be a single OFDM symbol, or may be composed of multiple OFDM symbols.

In FIGS. 8 and 9, an embodiment may be illustrated in which an ISAC system performs only communication in a first time slot (Time slot 1). It can be seen that communication is allocated to all resource blocks (RBs) in the first time slot (Time slot 1). This shows that frequency resources are utilized in the same manner as performance of typical wireless communication and that, when interference between adjacent cells is not present, frequency resources in the same band may be utilized and different subcarriers within the bandwidth may be used to avoid interference with adjacent cells.

It can be seen that an embodiment in which the ISAC system performs only sensing in a second time slot (Time slot 2). Sensing may be allocated to all resource blocks (RBs) in the second time slot (Time slot 2).

In the second time slot, frequency resources in the same band may also be utilized for sensing when interference between adjacent cells is not present, similar to the first time slot, and different subcarriers may be used to avoid interference with adjacent cells. In this case, as illustrated in FIG. 9, subcarriers may be allocated in an interleaved manner, or may be used in a block-wise manner. Also, because wireless communication and frequency resources are separated and used in a time domain, radar waveforms in schemes other than the OFDM scheme may also be used for sensing. Further, sensing in the same band may be used for sensing in other purposes as well as for weather observation. Here, in the time slot, different waveforms may be used for different purposes, wherein guard intervals may be inserted to avoid interference between RBs.

An embodiment is illustrated in which the ISAC system performs communication and sensing together in a third time slot (Time slot 3). In order to perform communication and sensing together within a given bandwidth, regions are distinguished from each other in units of RB, and the same waveform may be used for communication and sensing, as in the case of OFDM, or different waveforms may be used. In order to prevent performance degradation of communication, sensing may be performed using an OFDM waveform having the same subcarrier space, or may be performed using other waveforms in consideration of the purpose and performance of sensing, wherein a guard interval may be inserted into each RB to which sensing is allocated.

An embodiment is illustrated in which the ISAC system performs communication and sensing together in a fourth time slot (Time slot 4), and in which, when performance required for sensing is higher, more frequency resources may be utilized within a given bandwidth as needed. In this case, frequency resources in adjacent RB units are not necessarily utilized, and frequency resources may be utilized in various forms such as in a fifth time slot (Time slot 5).

Furthermore, sensing is not limited to the utilization of a monostatic scheme as shown in the examples of the second and third time slots in FIG. 9, and may also be utilized in a bistatic or multistatic manner as in the case of the fifth time slot. When sensing is used in the bistatic manner as in the example of the fifth time slot, the same frequency may be used in units of RB.

It can be seen that, in a sixth time slot (Time slot 6), the ISAC system performs its original communication function again when sensing is not required.

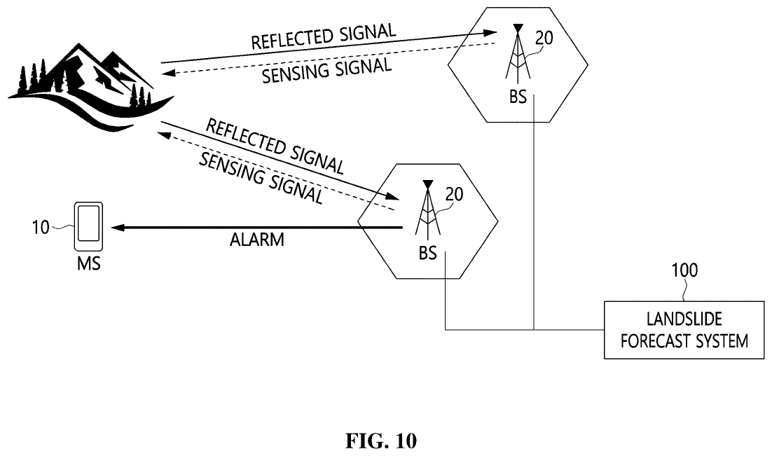

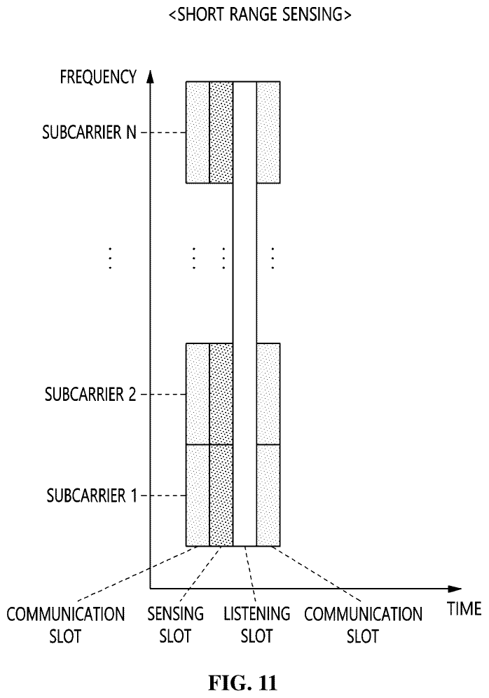

FIG. 10 is a diagram illustrating a weather observation system using communication base stations for landslide forecasting according to an embodiment of the present disclosure.

Referring to FIG. 10, it can be seen that the weather observation system using communication base stations for landslide forecasting is illustrated.

Each communication base station 20 may transmit a transmission signal to an area at risk of a landslide.

Each communication base station 20 may analyze a sensing signal reflected from the transmission signal and determine the degree of landslide risk based on the moisture-content information of a target object.

Further, the weather observation apparatus 100 using communication base stations may analyze the sensing signals received from the communication base stations 20 and then determine the degree of landslide risk from the moisture-content information of the target object.

Here, presence or absence of landslide risk may be independently determined by respective communication base stations 20, or may also be determined by the weather observation apparatus 100 using communication base stations by aggregating pieces of information received from the respective communication base stations 20. If the degree of landslide risk is determined to be high, landslide risk information may be transmitted to the user terminal 10.

The weather observation apparatus 100 using communication base stations may determine whether there is a landslide risk based on the phase variation and magnitude variation of the reflected signal.

Here, the weather observation apparatus 100 using communication base stations may determine that a landslide is imminent when phase variation equal to or greater than a preset value appears periodically.

Furthermore, the weather observation apparatus 100 using communication base stations may determine whether there is a landslide risk based on the magnitude variation of the reflected signal that changes depending on the moisture content of soil.

Here, the weather observation apparatus 100 using communication base stations may determine that a landslide is imminent when the magnitude of the reflected signal becomes greater than that of dry soil by a preset value or more.

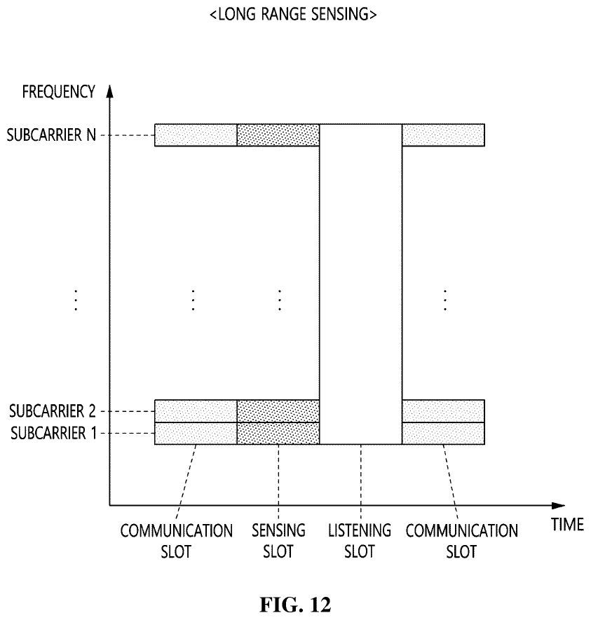

FIGS. 11 and 12 are diagrams illustrating changes in numerology depending on measurement distance according to an embodiment of the present disclosure.

Referring to FIGS. 11 and 12, it can be seen that changes in numerology for methods such as dividing the frequency band, assigning time slots, and adjusting the subcarrier spacing to efficiently allocate resources in the ISAC system are illustrated.

It can be seen that FIG. 11 illustrates changes in numerology in short range sensing, and FIG. 12 illustrates changes in numerology in long range sensing.

Here, “numerology” refers to numerology in 3rd Generation Partnership Project New Radio (3GPP NR).

A sensing slot may be used to transmit a signal for sensing. In the sensing slot, each resource element may transmit a transmission signal having a pulse shape that is as narrow as possible in the time domain by transmitting a signal having the same phase. Here, the pulse signal that is transmitted corresponds to the form of one of various types of sensing signals, and is not limited to the case where a sensing signal is used only as a pulse signal. When the target desired to be sensed is located farther, a listening slot may be allocated. Neither uplink nor downlink signals are allocated to the listening slot, and the listening slot may be used to receive a signal obtained when a transmitted sensing signal is reflected from the target. As the location of the maximum target is disposed farther, numerology having narrower Sub-Carrier Spacing (SCS) may be used.

The sensing slot and the listening slot may be disposed between communication slots. The listening slot may be allocated when the delay time of the reflected signal depending on the distance of the target is greater than one slot. Here, the listening slot may be disposed adjacent to the sensing slot and after the sensing slot.

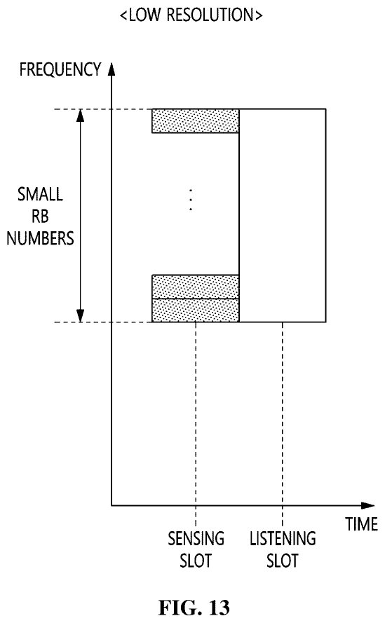

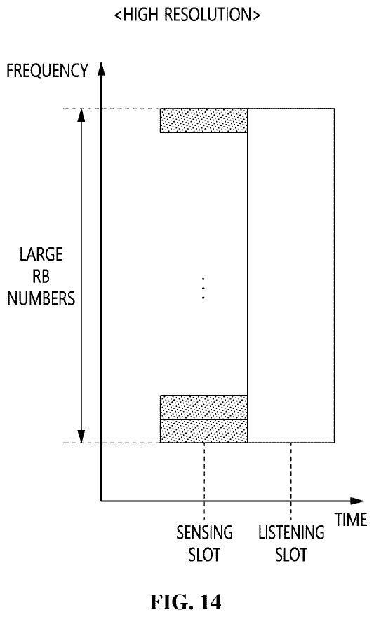

FIGS. 13 and 14 are diagrams illustrating changes in the number of Resource Blocks (RBs) depending on the required resolution according to an embodiment of the present disclosure.

Sensing resolution may be adjusted so that, as illustrated in FIG. 13, when sensing resolution required for imaging of a sensing signal is lower, a smaller number of RBs are allocated, and so that, as illustrated in FIG. 14, when the sensing resolution required for imaging is higher, a larger number of RBs are allocated.

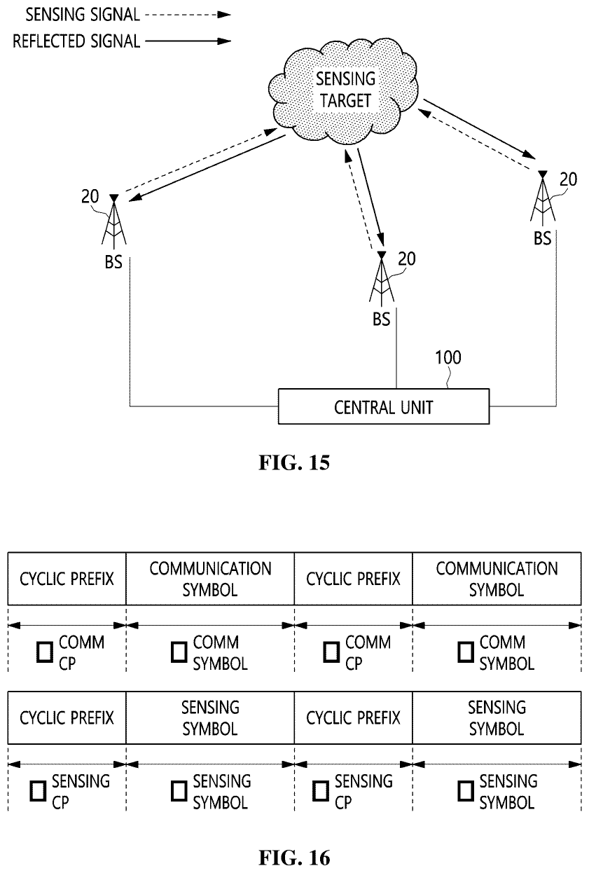

FIG. 15 is a diagram illustrating a process of extracting information about a target object using multiple communication base stations according to an embodiment of the present disclosure.

Referring to FIG. 15, in the present disclosure, data may be processed by collecting sensing information obtained from individual communication base stations 20 so as to improve the accuracy of information about the target object. In FIG. 15, an embodiment is illustrated in which multiple base stations using a monostatic scheme extract sensing data for a sensing target object. The multiple communication base stations 20 may perform sensing, and thereafter transmit sensing data to a central unit 100. The central unit 100 may extract information about the target object by aggregating the sensing data received from respective communication base stations 20. The central unit 100 may extract various types of information about the target object as the target object is moving. Similar to this, a multistatic scheme may also accurately extract information about the target object through the central unit 100.

By means of this, the present disclosure may accurately determine localized precipitation changes, landslide risks, or the like through the communication base stations 20, may create a new service and pricing plan for providing moisture-content information obtained based on the determination results, and may provide the new service and pricing plan to the user.

FIG. 16 is a diagram illustrating the Cyclic Prefix (CP) length of a sensing symbol according to an embodiment of the present disclosure.

Referring to FIG. 16, unlike a communication Cyclic Prefix (CP) set to a specific length depending on the amount of delay spread, a sensing CP may be dynamically changed based on Equation (3). In Equation (3), Rₘₐₓ denotes the distance of a target object placed at the farthest location, and C denotes the speed of light.

$${τ}_{CP}^{Sensing} = \frac{2 {R}_{max}}{C} \qquad ( 3 )$$

The weather observation apparatus and method using communication base stations according to embodiments of the present disclosure may distinguish sensing signals from each other using the cell IDs of communication base stations in monostatic and bistatic schemes.

Further, the weather observation apparatus and method using communication base stations according to embodiments of the present disclosure may identify sensing signals transmitted from multiple wireless communication base stations, and may cooperatively use the bistatic scheme based on the identified sensing signals when the bistatic scheme is used.

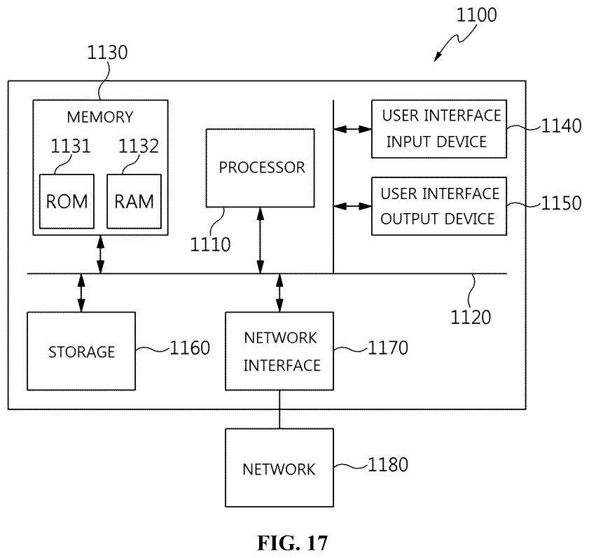

FIG. 17 is a diagram illustrating a computer system according to an embodiment of the present disclosure.

Referring to FIG. 17, a weather observation apparatus 100 using communication base stations according to an embodiment of the present disclosure may be implemented in a computer system 1100 such as a computer-readable storage medium. As illustrated in FIG. 17, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

A weather observation apparatus 100 using communication base stations according to an embodiment of the present disclosure may include one or more processors 1110 and memory 1130 configured to store at least one program that is executed by the one or more processors 1110, wherein the at least one program is configured to receive a sensing signal, obtained from a target object for weather observation, from at least one communication base station, correct the sensing signal using metadata based on at least one of a location of the communication base station, a condition of a communication network or a distance to the communication base station, or a combination thereof, analyze a weather change of the target object by analyzing a strength and a delay time of the sensing signal, and provide weather observation information to a user terminal based on the weather change.

Here, the communication base station may receive a sensing signal that is reflected from the target object when another communication base station transmits a transmission signal to the target object.

Here, the at least one program may be configured to estimate three-dimensional (3D) coordinates of a rain cloud by forming ellipsoids in a 3D coordinate system using a propagation path based on coordinate information of communication base stations and a delay time between a transmission signal and a sensing signal of the communication base stations.

Here, the at least one program may be configured to determine whether the target object is at a landslide risk based on a phase variation and a magnitude variation of the sensing signal.

Here, the at least one program may be configured to provide a weather observation service for delivering personalized weather observation information and provide a customized pricing plan based on at least one of a location, an environment or a communication network condition of the user terminal, or a combination thereof.

Here, the at least one program may be configured to schedule a frequency-resource utilization ratio for allocating frequency resources of the communication base station between a communication purpose and a sensing purpose for weather observation.

Here, the at least one program may be configured to allocate any one of the communication purpose and the sensing purpose for weather observation to each of frequency resource blocks included in each time slot corresponding to Orthogonal Frequency-Division Multiplexing (OFDM) symbols.

Here, the at least one program may be configured to, when a frequency resource block to which the communication purpose is allocated and a frequency resource block to which the sensing purpose is allocated are adjacent to each other, insert a guard interval into the frequency resource block to which the sensing purpose is allocated.

Here, the at least one program may be configured to schedule a number of sensing purposes allocated to the frequency resource blocks based on a preset resolution for collecting the sensing signal.

The present disclosure may allow a communication base station to additionally provide a weather observation function as well as an existing communication function by utilizing an existing wireless communication base station and a next-generation wireless communication base station system.

Further, the present disclosure may detect in real time sudden weather changes occurring in various terrains, including not only urban areas but also mountainous and coastal regions, and may establish a safety system for localized weather forecasting and disaster response based on such detection.

Furthermore, the present disclosure may collect weather information over a wide area and integrate metadata collected from a communication network, thus providing high-precision weather analysis information, such as localized precipitation, landslide risks, and weather changes, in real time.

Furthermore, the present disclosure may establish a comprehensive weather observation and user service system that provides personalized weather information to a user and proposes customized pricing plans and services according to weather changes.

Furthermore, the present disclosure may identify sensing signals from multiple wireless communication base stations and individually or cooperatively use the sensing signals, thus eliminating observation blind spots of conventional weather-observation radars and improving the distance resolution of weather observations.

As described above, in the weather observation apparatus and method using communication base stations according to embodiments of the present disclosure, the configurations and schemes in the above-described embodiments are not limitedly applied, and some or all of the above embodiments can be selectively combined and configured such that various modifications are possible.

What is claimed is:

1. A weather observation apparatus using communication base stations, comprising:
one or more processors; and
a memory configured to store at least one program that is executed by the one or more processors,
wherein the at least one program is configured to:
receive a sensing signal, obtained from a target object for weather observation, from at least one communication base station,
correct the sensing signal using metadata based on at least one of a location of the communication base station, a condition of a communication network or a distance to the communication base station, or a combination thereof,
analyze a weather change of the target object by analyzing a strength and a delay time of the sensing signal, and
provide weather observation information to a user terminal based on the weather change.

2. The weather observation apparatus of claim 1, wherein the communication base station receives a sensing signal that is reflected from the target object when an additional communication base station transmits a transmission signal to the target object.

3. The weather observation apparatus of claim 2, wherein the at least one program is configured to estimate three-dimensional (3D) coordinates of a rain cloud by forming ellipsoids in a 3D coordinate system using a propagation path based on coordinate information of communication base stations and a delay time between a transmission signal and a sensing signal of the communication base stations.

4. The weather observation apparatus of claim 1, wherein the at least one program is configured to determine whether the target object is at a landslide risk based on a phase variation and a magnitude variation of the sensing signal.

5. The weather observation apparatus of claim 1, wherein the at least one program is configured to provide a weather observation service for delivering personalized weather observation information and provide a customized pricing plan based on at least one of a location, an environment or a communication network condition of the user terminal, or a combination thereof.

6. The weather observation apparatus of claim 1, wherein the at least one program is configured to schedule a frequency-resource utilization ratio for allocating frequency resources of the communication base station between a communication purpose and a sensing purpose for weather observation.

7. The weather observation apparatus of claim 6, wherein the at least one program is configured to allocate any one of the communication purpose and the sensing purpose for weather observation to each of frequency resource blocks included in each time slot corresponding to Orthogonal Frequency-Division Multiplexing (OFDM) symbols.

8. The weather observation apparatus of claim 7, wherein the at least one program is configured to, when a frequency resource block to which the communication purpose is allocated and a frequency resource block to which the sensing purpose is allocated are adjacent to each other, insert a guard interval into the frequency resource block to which the sensing purpose is allocated.

9. The weather observation apparatus of claim 7, wherein the at least one program is configured to schedule a number of sensing purposes allocated to the frequency resource blocks based on a preset resolution for collecting the sensing signal.

10. A weather observation method using communication base stations, performed by a weather observation apparatus using communication base stations, the weather observation method comprising:
receiving a sensing signal, obtained from a target object for weather observation, from at least one communication base station;
analyzing a weather change of the target object by analyzing a strength and a delay time of the sensing signal; and
providing weather observation information to a user terminal based on the weather change,
wherein receiving the sensing signal comprises:
correcting the sensing signal using metadata based on at least one of a location of the communication base station, a condition of a communication network or a distance to the communication base station, or a combination thereof.

11. The weather observation method of claim 10, wherein the communication base station receives a sensing signal that is reflected from the target object when an additional communication base station transmits a transmission signal to the target object.

12. The weather observation method of claim 11, wherein analyzing the weather change comprises:
estimating three-dimensional (3D) coordinates of a rain cloud by forming ellipsoids in a 3D coordinate system using a propagation path based on coordinate information of communication base stations and a delay time between a transmission signal and a sensing signal of the communication base stations.

13. The weather observation method of claim 10, wherein analyzing the weather change comprises:
determining whether the target object is at a landslide risk based on a phase variation and a magnitude variation of the sensing signal.

14. The weather observation method of claim 10, wherein providing the weather observation information comprises:
providing a weather observation service for delivering personalized weather observation information and providing a customized pricing plan based on at least one of a location, an environment or a communication network condition of the user terminal, or a combination thereof.

15. The weather observation method of claim 10, further comprising:
scheduling a frequency-resource utilization ratio for allocating frequency resources of the communication base station between a communication purpose and a sensing purpose for weather observation.

16. The weather observation method of claim 15, wherein scheduling the frequency-resource utilization ratio comprises:
allocating any one of the communication purpose and the sensing purpose for weather observation to each of frequency resource blocks included in each time slot corresponding to Orthogonal Frequency-Division Multiplexing (OFDM) symbols.

17. The weather observation method of claim 16, wherein scheduling the frequency-resource utilization ratio further comprises:
when a frequency resource block to which the communication purpose is allocated and a frequency resource block to which the sensing purpose is allocated are adjacent to each other, inserting a guard interval into the frequency resource block to which the sensing purpose is allocated.

18. The weather observation method of claim 17, wherein scheduling the frequency-resource utilization ratio further comprises:
scheduling a number of sensing purposes allocated to the frequency resource blocks based on a preset resolution for collecting the sensing signal.
